(19) United States
(12) Patent Application Publication
(10) Pub. No.: US 2016/0034924 A1
(43) Pub. Date: Feb. 4, 2016

(54) ESTIMATING DISTRIBUTION OF PERSONS IN A PHYSICAL ENVIRONMENT

(71) Applicant: Shopper Scientist LLC, Corbett, OR (US)

(72) Inventor: Herb Sorenson, Corbett, OR (US)

(21) Appl. No.: 14/884,714

(22) Filed: Oct. 15, 2015

Related U.S. Application Data
(63) Continuation-in-part of application No. 13/350,461, filed on Jan. 13, 2012.
(60) Provisional application No. 61/432,733, filed on Jan. 14, 2011.

(51) Int. Cl. G06Q 30/02; H04W 4/02

(52) U.S. Cl. CPC G06Q 30/0201; H04W 4/02

(57) ABSTRACT

Tracking systems and methods of estimating a distribution of persons in a physical environment are provided. A tracking system may comprise a wireless receiver configured to detect instances of a wireless signal from each mobile device passing through an entryway in and out of the environment and a computing device configured to identify an identifier transmitted in each instance and compute a trip time for each mobile device and an aggregate trip time spent by all mobile devices during an analysis period. The computing device may read a probability map that indicates a probability that one of the mobile devices is located in each predetermined location and oriented in a predetermined direction. The computing device may assign each time unit a predetermined location and orientation based on the probability map, and for a selected target location, compute and display an aggregate time and a probability distribution of shopper orientation.

### CROSS REFERENCE TO RELATED APPLICATIONS

The present application is a continuation-in-part of U.S. patent application Ser. No. 13/350,461 filed Jan. 13, 2012, entitled “Detecting Shopper Presence in a Shopping Environment Based on Shopper Emanated Wireless Signals,” which in turn claims priority to U.S. Provisional Patent Application Ser. No. 61/432,733 filed Jan. 14, 2011, the entire contents of both of which are incorporated herein by reference for all purposes.

### BACKGROUND

Consumers purchase goods in a wide variety of shopping environments. To better direct their marketing efforts and increase sales, manufacturers and retailers of goods often strive to gather accurate information concerning consumers' shopping habits to more effectively market their goods, and thereby increase sales.

One prior method for identifying shoppers' habits involves collecting surveys filled out by shoppers. One drawback to surveys is that shoppers are often busy and it may be difficult to incentivize them to complete surveys. Another drawback is that much shopping behavior is subconscious behavior that shoppers are unable to self report. Moreover, the information provided by shoppers may not be accurate due to forgetfulness, laziness, or even in some cases deceitfulness. Thus, many surveys may not accurately reflect shoppers' habits, thereby decreasing the reliability of the results collected from the survey and potentially leading to an improper marketing analysis.

Another prior method for identifying shoppers' habits involves human observers physically counting and tracking shoppers' interactions (e.g., pathways, purchases) within the store. However, it may be costly and inefficient to employ human observers to track a shopper's shopping habits.

Yet another prior art method involves embedding radio frequency identification (RFID) or ultra wideband (UWB) emitters in a shopper surrogate such as a shopping cart, and tracking the movements of the shopper via signals emitted from the emitter and detected by remote RFID or UWB tracking equipment placed at various locations in the store. These systems attempt to track shopper trips that occur when shoppers pick up and/or move with each shopper surrogate. It will be appreciated that a single shopping cart may be used by several shoppers during the day. The systems attempt to distinguish between shopper trips by sensing when each cart is departs from a cart return area or enters the store, and accordingly marking the beginning of a shopping trip, and also sensing when the cart is returned to a cart return area or exits the store, and accordingly marking the end of the same shopper trip within tracking data for the cart.

However, it is complicated to make such determinations using surrogate tracking systems, and as a result they suffer from the additional drawback that they are prone to error. Each time a shopper abandons a shopping cart within the store, empties the shopping cart in the store and hands it off to another shopper, leaves with the cart via an unmonitored exit, etc., errors will be produced in the tracking data. Even one abandoned or handed-off cart per hour in a store can produce large errors in the tracking data, since these carts may be erroneously attributed with extremely long shopper trip lengths by the tracking system. Additionally, for as many as one-third of shopping trips, the shopper may not use a cart, and thus are poorly represented by such surrogate tracking systems.

### SUMMARY

Systems and methods for detecting the presence of shoppers in a shopping environment are provided. The system may include a receiver configured to receive short range wireless transmissions from mobile transmitters coupled to shoppers passing through a monitored area of the shopping environment, identify substantially unique characteristics of the wireless transmissions, and generate detection data indicating the presence of the shoppers in the monitored shopping area based on the substantially unique characteristics in each of the wireless transmissions, and a computing device configured to receive the detection data from the receiver and determine statistical data based on the detection data. The mobile transmitter may be included in an earpiece for a cellular phone, headphones, a mobile phone, or a wireless dongle coupled to a computing device, for example. The wireless transmission may be sent via a short range radio signal such as a BLUETOOTH® signal. In this way, the tracking system may utilize devices in use by many consumers in day-to-day shopping trips, in order to generate data relating to shopper behavior.

Further provided are tracking systems and methods of estimating a distribution of persons in a physical environment. The tracking system may comprise a wireless receiver configured to detect a first instance of a wireless signal of a mobile device of each of a plurality of persons passing through an entryway into a shopping environment, and detect a second instance of the wireless signal from each mobile device passing through the entryway out of the shopping environment. The tracking system may further comprise a computing device configured to identify an identifier transmitted in each of the first instances of the wireless signals, mark an entrance time for each of the mobile devices to the shopping environment based on the identification of the wireless identifier, detect the wireless identifier transmitted in each of the second instances of the wireless signals, mark an exit time for each of the mobile devices based upon the detection of the wireless identifier, compute a trip time for each of the mobile devices based on the entrance time and exit time of each mobile device, and compute an aggregate trip time spent by all mobile devices in the shopping environment during an analysis period. The computing device may be further configured to read a probability map of the shopping environment that indicates for a plurality of predetermined locations in the shopping environment, a probability that one of the mobile devices is located in each predetermined location, and a probability that the mobile device is oriented in a predetermined direction within each predetermined location, divide the aggregate trip time into multiple time units, allocate the time units to each of the predetermined locations based on the probability map, such that each time unit is assigned a predetermined location and orientation, and for a target location selected from the predetermined locations within the shopping environment, compute an aggregate time estimation indicating the aggregate time spent by shoppers in that location, and a probability distribution of shopper orientation, based on the time units allocated to the target location based upon the probability map. Finally, the computing device may display on a display associated with the computing device, for the target location, the probability distribution.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE FIGURES

FIG. 1 shows a schematic depiction of an example shopper detection system or tracking system.

FIG. 2 shows a schematic depiction of an alternative embodiment of the shopper detection system shown in FIG. 1.

FIG. 3 shows a method for detecting the presence of shoppers in a shopping environment.

FIG. 4 shows an illustration of a statistical graph that correlates the percentage of total shoppers to the minutes those shoppers are in a store.

FIG. 5 shows an illustration of a statistical graph that indicates, for each of two example store, the percentage of shoppers that spend a given number of minutes in each store during a shopping trip.

FIG. 6 shows an illustration of an allocated probability map generated by the tracking system of FIG. 1.

FIG. 7 shows an illustration of a probability distribution for a target location of the allocated probability map.

FIGS. 8A and 8B show a method of estimating a distribution of persons in a physical environment.

### DETAILED DESCRIPTION

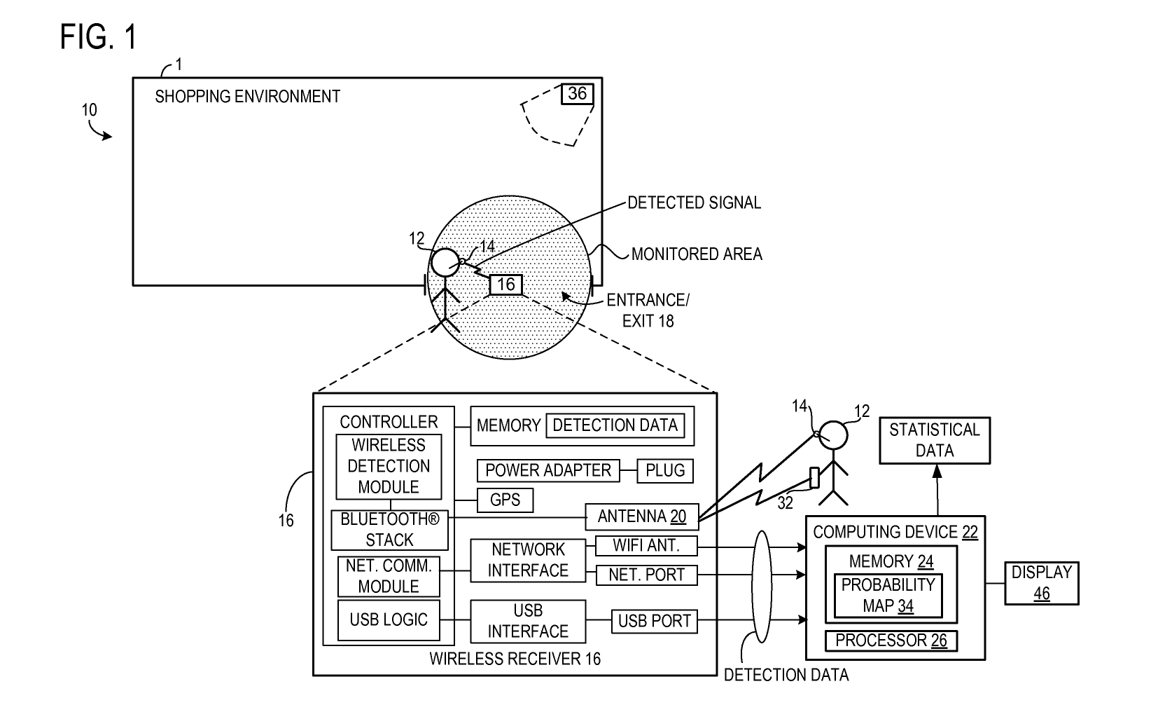

FIG. 1 shows a schematic depiction of an example shopping environment 1. It will be appreciated that the shopping environment 1 may be, for example, a physical building serving as a retail location in which various products are offered for sale. Example shopping environments include supermarkets, clothing retailers, department stores, hardware stores, restaurants, bazaars, malls, etc.

A system 10 for detecting the presence of shoppers in the shopping environment is provided herein. Some of the shoppers 12 that enter shopping environment 1 may possess short range wireless transmission devices 14 on their person. In many circumstances short range wireless transmission devices are paired with other devices to provide wireless communication. For example, a mobile phone and a wireless earpiece may both utilize the BLUETOOTH® standard to wirelessly communicate via short range radio signals. As another example, a portable media player may wirelessly communicate with a wireless pair of headphones via short range radio signals. It will be appreciated that short range wireless transmission devices 14 may be any of the aforementioned or any other short range wireless transmission devices, which emit transmissions with substantially unique characteristics that can be used to distinguish the transmissions of one shopper's device from another. Additional short range wireless transmission devices may also include, but are not limited to include, a universal serial bus (USB) dongle for a portable computing device.

It is commonplace for a shopper to utilize a short range wireless transmission device in shopping environments. For example, a shopper may carry out a conversation on a mobile phone using a hands free Bluetooth® earpiece. This short range radio transmission device may transmit packets of data via 79 bands (1 MHz each) in the range of 2402-2480 MHz in accordance with accepted Bluetooth® standards. Other short range frequencies and protocols may be used for wireless transmission in other embodiments. The sample of shoppers 12 carrying such short range wireless transmission devices may be around 5-15%.

The tracking system 10 may include at least one receiver 16 configured to receive wireless signals from the short range wireless transmission devices 14. Receiver 16 may include a controller, such as an application specific integrated circuit, processor, etc., and associated memory. The controller may be configured to implement a wireless detection module to receive and process signals from transmission devices 14 via an antenna 20. The antenna may be a unidirectional antenna or a directional antenna (e.g., “cantenna”), configured to receive signals from transmitters in a monitored area of interest. The wireless detection module may be configured to utilize a BLUETOOTH® stack to interpret signals according to the BLUETOOTH® standard. The wireless detection data may further be configured to store detection data indicating the detected presence of the wireless transmissions from the transmission devices 14 in the associated memory.

The controller may further be configured to implement a network communications module that is configured to communicate via a network interface and associated WIFI antenna or network port with the computing device 22, to send the detection data to the computing device over a wired or wireless network connection, respectively, for downstream processing. In addition or in the alternative, the receiver may be configured as a USB device, and thus may include USB logic executed by the controller, as well as a USB interface and port that are used to communicate the detection data to the analyzer 22.

It will be appreciated that receiver 16 may be positioned within the shopping environment or may be positioned at a remote location external to the shopping environment. In one example, the antenna may be focused on an entrance/exit 18 location in the shopping environment. In this manner the receiver 16 can receive signals from the entrance/exit 18. It follows that the receiver 16 may determine the number of shoppers having a short range wireless transmission device that enter and exit the shopping environment via the entrance/exit 18.

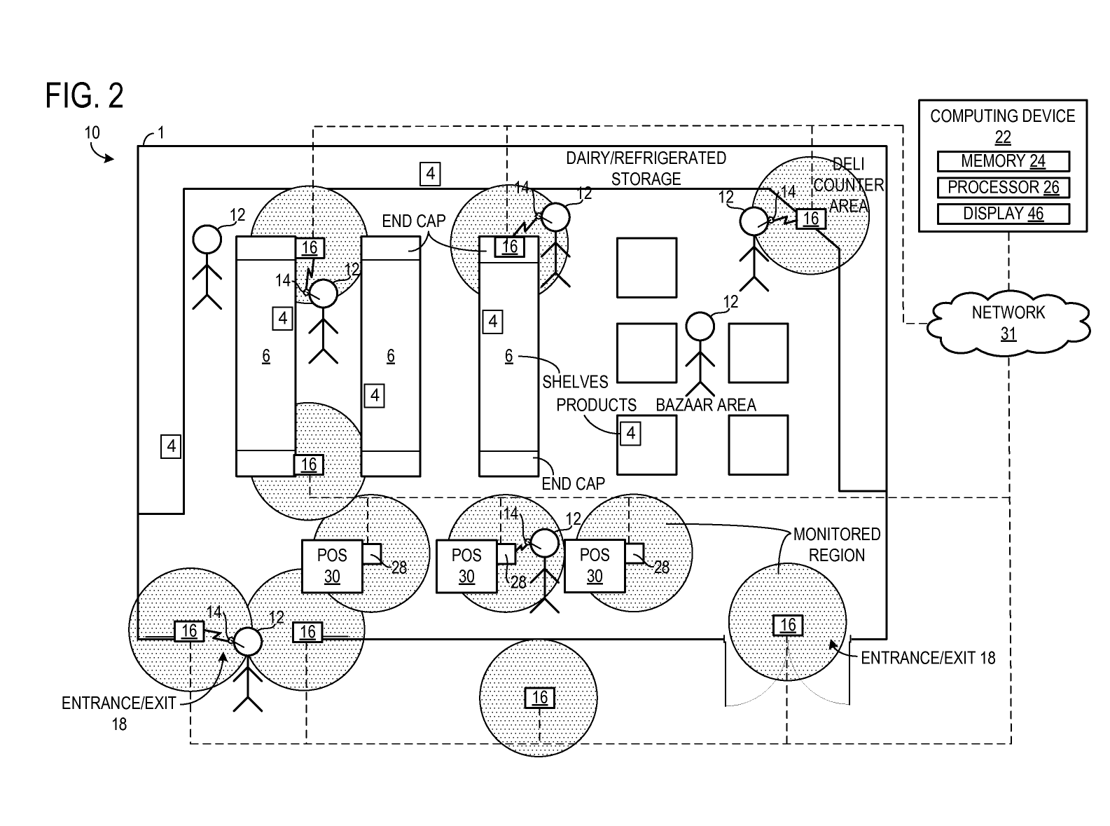

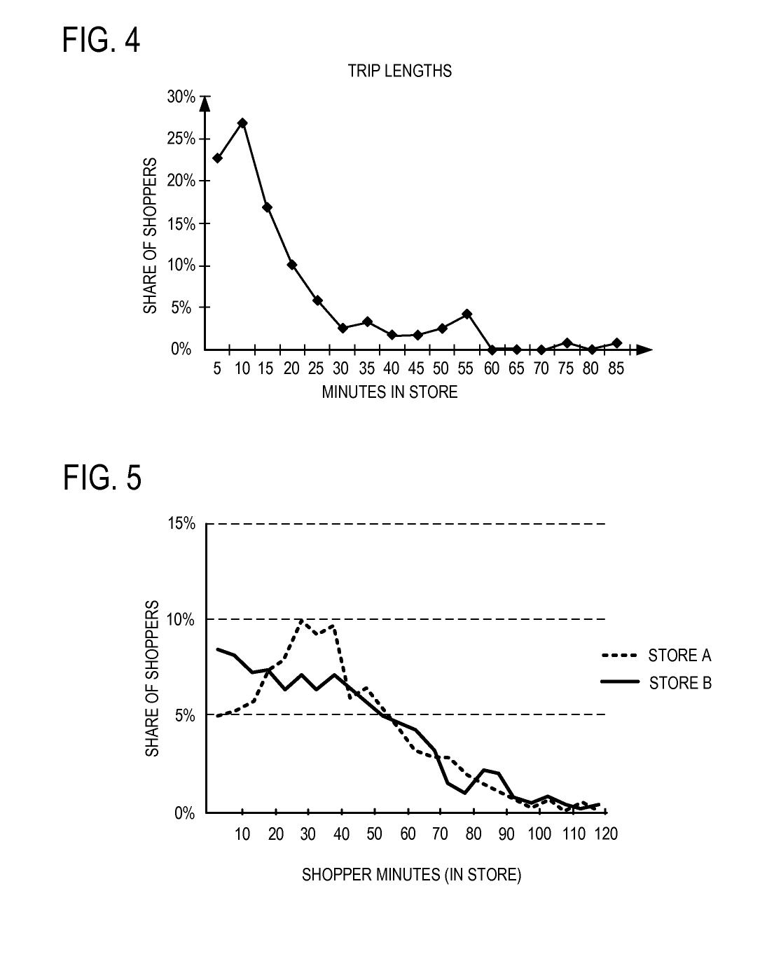

In addition or in the alternative, as shown in FIG. 2, receivers 16 may be placed in other departments or regions of the store to similarly track shopper entrances and exits from those departments or regions. For example, a receiver may be deployed to monitor shopper entrances and exits from the deli counter area, produce department, meat department, dairy department, or a given aisle in the store, for example. Receivers 16 may be used in different locations in the store concurrently in some embodiments, so that entrances and exits for the same shopper may be compared in different locations. Thus, the system may be able to determine whether on a specific day a given shopper entered both the store as a whole and also the produce department, and may be able to identify how long the shopper spent in both the store as a whole, and within the produce department. Further, the system may identify whether the shopper made multiple trips to the produce department or indeed to the store, in the same day, and may gather aggregate dwell time in each over the day. Further, other suitable observation periods may be established, such as over a month, and the system may track, for each unique shopper, multiple visits to the monitored shopping area (store/department) over the observation period. An aggregate visit count, and trip time may be calculated over the entire period for each shopper. Further, for all shoppers during the observation period, statistical measures such as average trip length may be computed. Further, trip length percentiles may be computed, as shown in FIG. 4 and described below. In this manner, the tracking system 10 may unobtrusively gather statistical data relating to shoppers in the shopping environment.

Suitable mounting locations for receiver 16 within the shopping environment may include, but are not limited to include, a wall, an entrance, an exit, an aisle, etc. In one example, the receiver 16 may be integrated into a cover plate of an electrical outlet, and in another example the receiver may include an integrated power plug that plugs into a power outlet. The receiver 16 may be configured to draw power from the electrical outlet. In this way, the receiver 16 may be inconspicuously placed in the shopping environment 1. The receiver 16 may also be configured to avoid interference with the operation of the electrical outlet, such that the outlet may provide power to other devices. In another example, the receiver may be battery operated, and include an on-board battery supply.

Returning to FIG. 1, additionally, the receiver 16 may include a global positioning satellite (GPS) unit that enables locating the receiver via a spaced based global navigation system, which may facilitate more extensive statistical analysis of shoppers' behaviors. For example, such GPS enabled receivers 16 may be deployed in stores across the country and may also be configured with the ability to log in to computer networks, for example via a wireless (e.g., WIFI) or wired (e.g. power line communication) network connection, and transmit reports to a central server that include data gathered for each receiver, as well as the GPS-detected location for each receiver. In this manner, large numbers of such receivers may be efficiently managed. Further, the receiver 16 may include a power adapter and associated power plug fitted coupled to a housing of the receiver. In this manner, the receiver 16 to be installed in and powered by a power outlet in the shopping environment 1.

Upon initial installation of the receiver 16, the receiver may be calibrated to ensure its accuracy according to the following process. Video cameras may be installed in the monitored shopping areas and video images may be recorded of shoppers traveling through the monitored area. Technicians may count the actual number of shoppers entering and exiting the monitored area based in the video images, and may compare this to the number of shoppers emanating wireless signals that were counted by the receiver 16. A calibration factor is computed which relates the number of actual shoppers to the number of shoppers detected by receivers 16 during the calibration period. In another example, the calibration factor may be calculated by using the time stamp of each purchase in a transaction log to determine an accurate count of all purchasers in the shopping environment, which can then be compared to the number of shoppers detected by the receivers 16. After calibration, this factor is used to compute an estimated number of total shoppers during an observation period based on the number of shoppers detected via receiver 16. As one example, if there are N detected shoppers, it may be determined that there are 3.4*N actual shoppers.

Further, to ensure data integrity and eliminate errors, a minimum trip length and a maximum trip length are established, and detected trip lengths for a given shopper that fall below the minimum trip length or exceed the maximum trip length will be ignored when computing shopper trip statistics, such as total trip time for each shopper and average trip time for all shoppers. This helps avoid anomalies that may otherwise erroneously skew the data.

As discussed above, the tracking system 10 may further include a computing device 22. The computing device 22 may include a memory 24 executable by a processor 26, and may be configured to receive detection data from the one or more receivers, as described above. It will be appreciated that the computing device 22 may be positioned at a remote location external to the shopping environment 1, such as at the central server described above. In other embodiments the computing device 22 may be positioned within the shopping environment. Computing device 22 may be in wired and/or wireless communication with receiver 16. Specifically, the computing device 22 may receive detection data from each of the short range wireless transmission devices 14 within the shopping environment 1. The computing device 22 may be configured to determine statistical data from the detection data it receives.

Computing device 22 may be configured to determine the number of shoppers having a short range wireless transmission device entering and exiting the shopping environment. The computing device 22 may also determine if a shopper having a short range wireless transmission device is entering and/or exiting the shopping environment from a direction vector associated with the short range wireless transmission device. In some embodiments the computing device 22 may uniquely identify each short range wireless transmission device. In other embodiments unique identification may not be utilized. A counting module in the computing device 22 may be configured to determine the total number of shoppers in the shopping environment based on the number of shoppers having a short range wireless transmission device. More specifically, an average ratio of shoppers having short range wireless transmission devices to a total number of shoppers may be used to determine the total number of shoppers in the shopping environment. It will be appreciated that this data may be gathered for each shopping environment via survey, visual observation, etc., or may be gathered from a plurality of shopping environments.

A receiver 16 may be positioned adjacent to an entrance/exit of the shopping environment to determine the number of shoppers entering and exiting the shopping environment. If the receiver 16 includes a directional antenna, the antenna may be positioned to receive short range wireless signals travelling through an entrance/exit of the shopping environment. It will be appreciated that other suitable methods may be used to determine the number of shoppers having a short range wireless transmission device in the shopping environment.

Computing device 22 may also be configured to determine the total time a shopper having a short range wireless transmission device spends in the shopping environment. More specifically, the computing device 22 may determine when a short range wireless transmission device enters the shopping environment and may record a unique identifier associated with the device. In the BLUETOOTH® implementation, the unique identifier is MAC address of the BLUETOOTH® device. The computing device 22 may then start a timer for the device and stop the timer when the device (with the same unique identifier) is determined to have left the shopping environment. It will be appreciated that the length of a shopper's stay within the shopping environment may be useful in marketing analysis.

The computing device 22 may also be configured to determine a metric that equals the number of shoppers having a short range wireless transmission device multiplied by the time (e.g., seconds, minutes) these shoppers spend in the shopping environment. This metric may be referred to as shopper seconds. It has been found through statistical analysis that the probability of a shopper being positioned at a location is directly correlated to shopper seconds. For example, 5 shoppers in a given area for 10 minutes yields the same number of shopper seconds as 10 shoppers in the area for 5 minutes. Thus, determining the number of short range wireless transmission devices in the shopping environment along with the time these shoppers spend in the shopping environment may be used to measure the distribution of shopper seconds in the shopping environment.

Communication between the computing device 22 and the receiver 16 may be encrypted to prevent unwanted parties from accessing information contained therein. The communication may be implemented over a virtual private network (VPN) or the Internet. Computing device 22 may utilize a suitable operating system such as Linux, Windows, Mac Operating System (OS), etc. It will be appreciated that there may be a variety of intermediary devices that may facilitate the connection between the computing device 22 and receiver 16. For example, a routing device (not shown) positioned within or adjacent to the shopping environment may be configured to receive signals (e.g., wired/wireless) from receiver 16. The routing device may further be configured to relay the signals over a network (e.g., VPN) to computing device 22. The functionality of the computing device 22 may also be distributed among multiple computing devices in other embodiments. For example, a wireless tracking computing device (not shown) may be communicatively linked (e.g., wired and/or wireless) to receiver 16. In some cases the wireless tracking computing device may be located within or adjacent to the shopping environment. The wireless tracking computing device may be configured to determine various tracking data corresponding to the short range wireless transmission devices in the shopping environment. The wireless tracking computing device may also be communicatively linked to the computing device 22. In this manner, a portion of the computing device's functionality may be assigned to other computing devices.

FIG. 2 shows another embodiment of tracking system 10, with a plurality of receivers 16 installed in a shopping environment 1. Receivers 16 are placed adjacent the left and right entrance/exits 18, and configured to detect signals from wireless devices that are carried by some shoppers as they travel through a monitored area near the entrance/exit. The left entrance/exit 18 features a pair of receivers to cover the entire area of ingress and egress, while the right entrance/exit features only one receiver. In combination, data from these receivers monitoring this pair of entrances/exits can be used to detect shopper presence in each monitored area, and to determine, for each shopper, a total amount of time spent in shopping environment 1.

Further, receivers 16 may be placed adjacent point of sale terminals to monitor shopper presence adjacent particular terminals. By examining the time of the shopper presence at the point of sale terminal, it may be possible to link the shopper with purchase records from that point of sale terminal. In this manner, it can be determined what a particular shopper purchased.

Further, receivers 16 may be placed in other areas of interest in the shopping environment, such as near a deli counter area, or end caps. A pair of receivers may be placed at respective ends of one or more aisles in the store, to monitor traffic through that particular aisle, if desired.

It will be appreciated that by using multiple receivers in different locations in the shopping environment, statistical data may be generated that indicates the number of shopper visits to a particular store or region of a store, as well as the dwell time that each shopper spends in the store or region of the store, and further by examining POS data, the purchases of the shoppers may be related to the visit data and dwell time. Thus, such a system may be utilized to determined from the shopper presence detection data statistics for reach (visits), stopping power (shopping), holding power (buy time), and closing power (purchases) during the observation period.

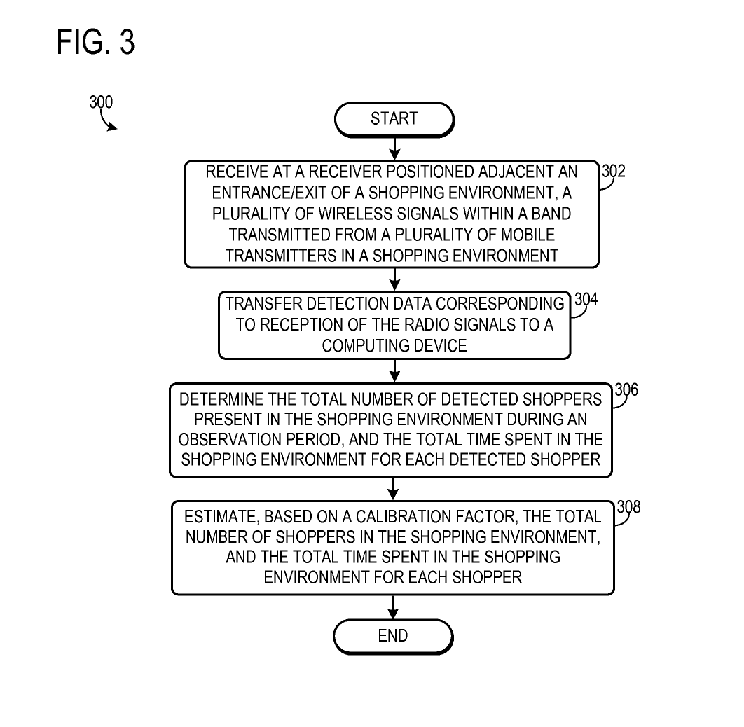

FIG. 3 shows one embodiment of a method 300 for detecting the presence of shoppers in a shopping environment. The method 300 may be implemented by the systems and components described above or alternatively may be implemented via other suitable systems and components. At step 302 the method includes receiving a plurality of wireless signals within a band transmitted from a plurality of mobile transmitters, such as short range radio transmission devices, in a shopping environment, as described above. In one embodiment of the method 300, step 302 includes receiving a plurality of radio signals within a short range radio frequency band, adjacent entrances/exits of the shopping environment.

At step 304 the method includes transferring data corresponding to the received radio signals to a computing device. In some embodiments step 304 may include transmitting detection data corresponding to the received radio signals. At step 306 the method 300 may include determining the total number of shoppers within the shopping environment based on the number of detected radio signals. This determination may be made based on a calibration of the system, as discussed above. At 308, the method may include, estimating, based on the calibration factor discussed above, the total number of shoppers in the shopping environment during an observation period, and the total time spent in the shopping environment for each shopper. It will be understood that the method 300 typically is performed with the one or more receivers placed at entrances/exits of the shopping environment. However, in other applications, the method may be applied to determine such statistics for a monitored area in another location internal or external to the shopping environment, as discussed above.

FIG. 4 shows an illustration of a graph depicting exemplary statistical data that may be generated via tracking system 10 discussed above. More specifically, FIG. 4 correlates the percentage of total shoppers (the “Share of Shoppers”) to the minutes those shoppers are in a shopping environment. It will be appreciated that other statistical data may be generated via tracking system 10 based on the detected presence of shoppers in the monitored areas.

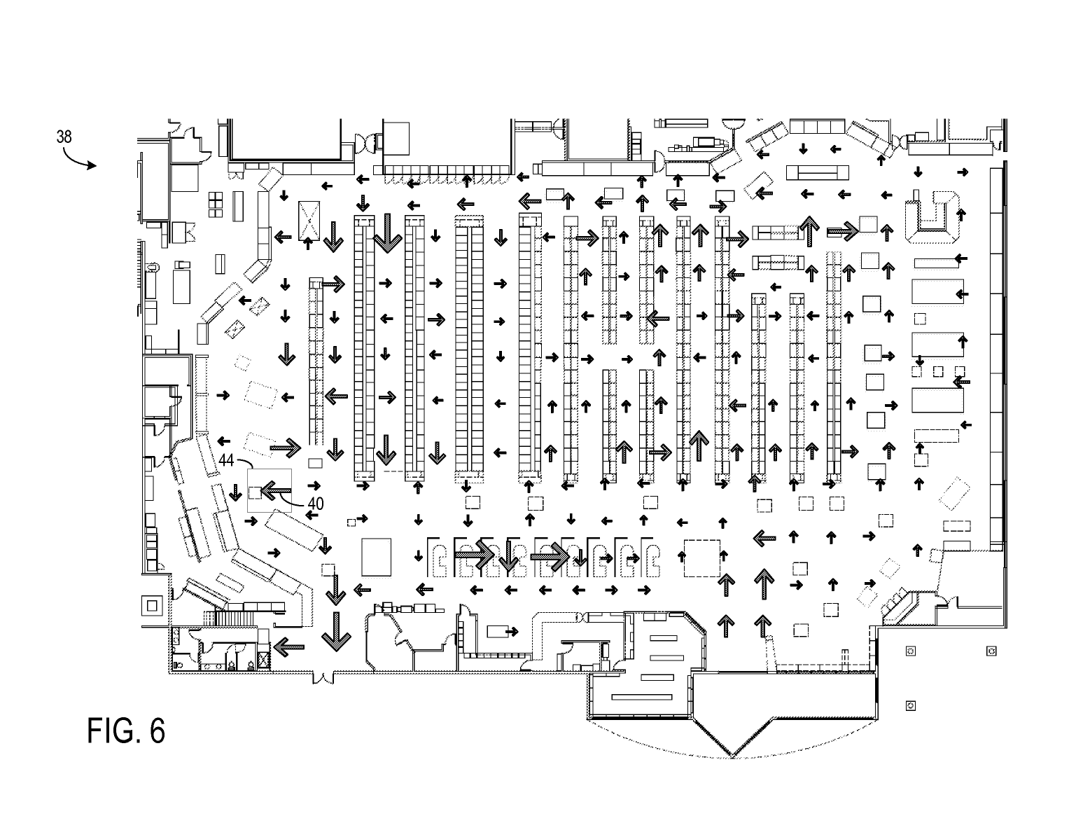

FIG. 5 shows an illustration of a statistical graph that indicates, for each of two example stores, the percentage of shoppers that spend a given number of minutes in each store during a shopping trip. From FIG. 5, it will be apparent that STORE B has the largest percentage of the trips at 5 minutes or less, and a fairly regular fall off in the percentage as the trip length increases. This has been found to be typical of a grid type store such as STORE B, which is a large store intersected by aisles. Such a floor plan is like an indiscriminate maze for shoppers to move through. This contrasts with STORE A, which has a floor plan with a dominant single path that the preponderance of shoppers follow after entering the store. In STORE A, the path moves down a single broad aisle to the back, across the back, and back to the front of the store. It has been found that dominant single path stores such as STORE A often sell more goods and services to customers, faster, than stores with grid floor plans like STORE B.

The tracking system 10 of FIG. 1 may be one example of a tracking system estimating a distribution of persons in a physical environment (e.g., the shopping environment 1). The tracking system 10 may comprise the wireless receiver 16, which may be configured to detect a first instance of a wireless signal of a mobile device 32 of each of a plurality of persons (e.g., shoppers 12) passing through an entryway (e.g., entrance/exit 18) into the shopping environment 1, and detect a second instance of the wireless signal from each mobile device 32 passing through the entryway out of the shopping environment 1. The short range wireless transmission device 14 or an associated device thereof may serve as the mobile device 32. The mobile device 32 may be a cellular phone, a mobile telephone, a smartphone, a tablet, a personal digital assistant, a wearable device, a mobile computing device, an accessory of the mobile telephone or mobile computing device, or a similar device capable of emitting wireless signals such as BLUETOOTH® signals. As mentioned above, the accessory may be an earpiece, a microphone, headphones, or a wireless dongle, to provide merely a few examples. Due to the ready availability of mobile devices 32 which emit BLUETOOTH® signals, the wireless signal may be a BLUETOOTH® signal, and the wireless identifier may be a MAC address of the mobile device 32. In some cases, the receiver 16 may include a global positioning system (GPS) unit to aid in tracking the mobile devices 32 and to allow for the receiver 16 to be easily relocated within the shopping environment 1.

The tracking system 10 may comprise the computing device 22, which may be configured to identify an identifier transmitted in each of the first instances of the wireless signals and mark an entrance time for each of the mobile devices 32 to the shopping environment 1 based on the identification of the wireless identifier. The computing device 22 may be configured to detect the wireless identifier transmitted in each of the second instances of the wireless signals, mark an exit time for each of the mobile devices 32 based upon the detection of the wireless identifier, and compute a trip time (i.e., trip length) for each of the mobile devices 32 based on the entrance time and exit time of each mobile device 32. Further, the computing device 22 may be configured to compute an aggregate trip time spent by all mobile devices 32 in the shopping environment 1 during an analysis period.

The computing device 22 may be configured to read a probability map 34 of the shopping environment 1 that indicates for a plurality of predetermined locations in the shopping environment 1, a probability that one of the mobile devices 32 is located in each predetermined location, and a probability that the mobile device 32 is oriented in a predetermined direction within each predetermined location. The probability map 34 may be stored in the memory 24 of the computing device 22 as illustrated in FIG. 1, or may be stored remotely and accessed via the network 31. The probability map 34 may be, for example, a database or spreadsheet, and may have an associated graphical representation. The various probabilities in the probability map 34 may be represented by, for example, Cartesian coordinates in three dimensions (x, y, z), a time stamp (t), and a velocity vector (v) including speed and orientation.

While the probability map 34 could be developed with a manual audit of the shopping environment 1, such an audit would likely be slow and inaccurate, and may result in too little data. Instead, the probability map 34 may be produced by a shopper tracking system that tracks radio frequency identification (RFID) tags, with RFID sensors throughout the shopping environment. In this case, the probability map 34 may further indicate a probability that the mobile device 32 is moving at a velocity within the predetermined location, by calculating velocities of the tracked RFID tags. Such a tracking system is described in U.S. Pat. No. 7,606,728, filed Sep. 19, 2003, the entirety of which is incorporated by reference herein. If numerous wireless receivers 16 are located throughout the shopping environment 1 and a sufficient portion of shoppers 12 carry applicable mobile devices 32, then the present tracking system 10 may be utilized in a similar manner.

The probability map 34 may be produced by an image-based shopper tracking system with still and/or video cameras 36 throughout the shopping environment 1. Footage from the cameras 36 may be analyzed to produce the probability map 34. For example, at every predetermined interval, the location and orientation of each shopper may be recorded based on the footage from the cameras 36. Every shopper may be counted if the actual number of shoppers has been calibrated as described above, even though not every shopper may be carrying a mobile device 32 or a wireless transmission device 14, or only an unbiased sample may be analyzed. The cameras 36 may be utilized to give a 100% sampling to improve accuracy over the surrogate method discussed above, and while the shoppers 12 with wireless transmission devices 14 may be around 5-15% of the total shoppers 12, characteristics of this small sample may be similar to that of the whole shopper 12 population. While a user of the computing device 22 may visually inspect the footage and record the positions and orientations of the shoppers 12, this may be a tedious procedure, and thus facial recognition algorithms may be executed by the computing device 22 to locate each shopper 12 and determine their orientations.

As another alternative, the probability map 34 may be produced by transaction log analysis linking shopper trips to locations of products 4 in the shopping environment 1. By using known product locations, purchase records from transaction logs, and optionally, previously determined customer flow models, the probability that one of the mobile devices 32 is located in each predetermined location, and the probability that the mobile device 32 is oriented in the predetermined direction within each predetermined location can be statistically determined. If a given product 4 is located at more than one location in a store, observed or statistically determined shopping behavior may be used to split the probability appropriately between the locations.

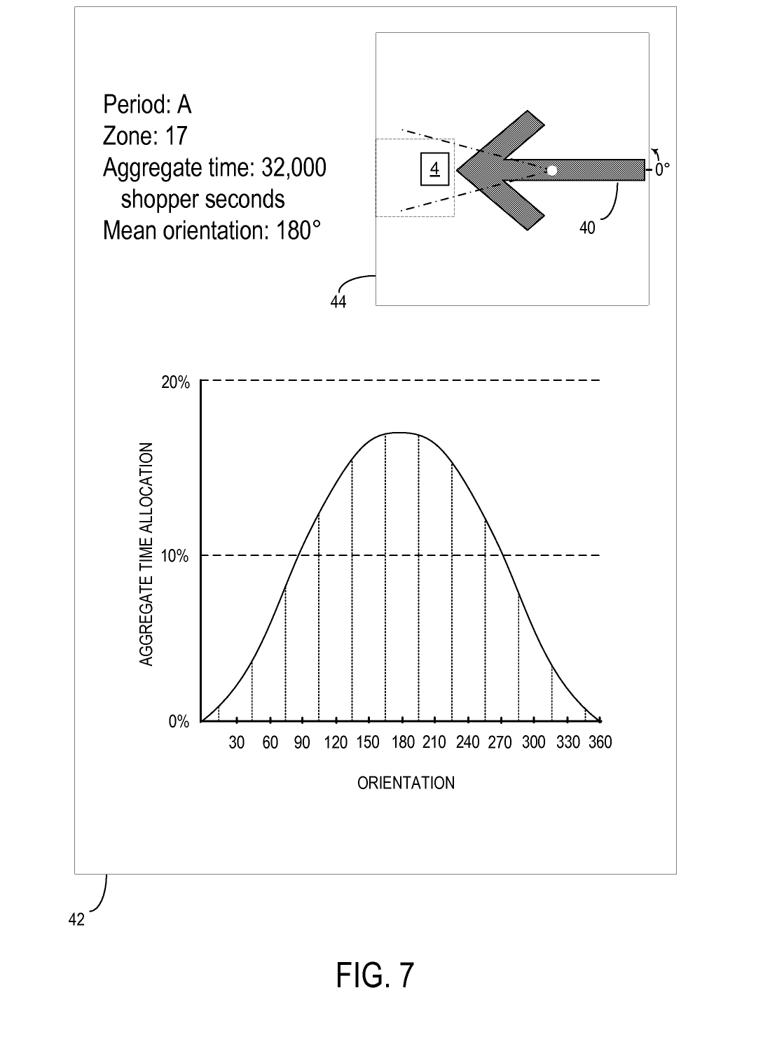

The computing device 22 may be configured to divide the aggregate trip time into multiple time units and allocate the time units to each of the predetermined locations based on the probability map 34, such that each time unit is assigned a predetermined location and orientation. The time units may be, for example, the shopper minutes or shopper seconds described above. Once allocated, the time units may provide information on how much exposure a given display, product 4, or area receives from the shoppers 12 based on the probability that a person carrying a mobile device 32 is at a given location, facing a given direction, and in some cases, moving at a given speed. FIG. 6 shows an illustration of an allocated probability map 38. The illustrated map includes a floor plan of a store with two entrance/exits 18. The store may be divided into predetermined locations in a grid, or may deviate from a grid to focus on areas of interest such as displays or to contour to a non-grid shape of the store. Each predetermined location in FIG. 6 has an indicator 40, illustrated as an arrow, which indicates the time units allocated to that predetermined location. In FIG. 6, the allocated time units are indicated by the relative size of the indicator 40, but other possible methods of indication include color, pattern, shape, transparency, number, and so on. The number of sizes is not particularly limited, and a scale or legend may be used to explain the probability indicated by each size of indicator 40. Text may be used instead of or in addition to the exemplary arrows, for example, so that the allocation may be displayed directly. However, the graphic representation illustrated in FIG. 6 allows a viewer to easily note differences between predetermined locations and patterns throughout the store, where text may be less obvious at a glance. Further, the indicators 40 may indicate the assigned predetermined orientation by the direction of the arrow or other suitable method. For simplicity, the dominant predetermined orientation per predetermined location may be displayed, although multiple arrows may instead be displayed per location.

It will be appreciated that other statistical measures may be indicated in the allocated probability map 38, instead of or in addition to location and orientation. For example, time units allocated based on a probability that a mobile device 32 is moving at a certain velocity may be indicated. Further, while the time units may be for all shoppers 12 in the entire shopping environment 1 for a given time period, the time units or shopper seconds may be filtered or limited by a number of factors which are not particularly limited. For example, only stops resulting in a purchase or not resulting in a purchase, trip lengths within a specified range, or certain zones or areas of the store may be of interest. The filters may produce data directed toward a specific product or brand, for instance.

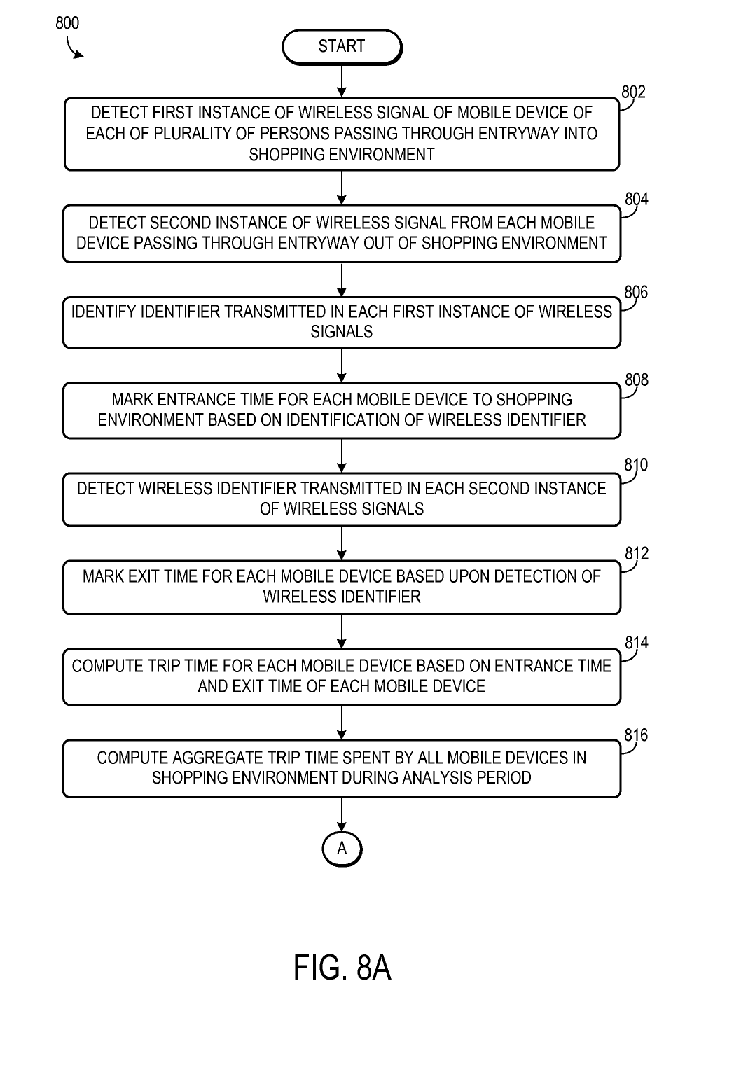

FIG. 7 shows an illustration of a probability distribution 42 for a target location 44 of the allocated probability map 38. The computing device 22 may be configured to, for a target location 44 selected from the predetermined locations within the shopping environment 1, compute an aggregate time estimation indicating the aggregate time spent by shoppers 12 in that location, and a probability distribution 42 of shopper orientation, based on the time units allocated to the target location 44 based upon the probability map 34. The computing device 22 may be configured to display on a display 46 (FIG. 1) associated with the computing device 22, for the target location 44, the probability distribution 42. As illustrated in FIG. 7, displaying the probability distribution 42 may comprise displaying at least one graph, and the probability distribution 42 may be displayed with a floor plan of the shopping environment 1.

In the example of FIG. 7, the indicator 40 shows that more shopper seconds are allocated to shoppers 12 facing left (180°) than any other direction, with a 30° range. Within that range is the product 4, so it can be determined that the portion of shopper seconds at the target location 44 allocated to a 180° orientation represent time shoppers spent with the product 4 in view. The probability distribution 42 is shown in graph form and has the aggregate time, in this case shopper seconds, allocated among 12 orientations, although the number of orientations is not limited to 12. The shopper seconds allocated to the orientation of 180° according to the probability distribution 42 is approximately 17% of the total allocated to the target location 44, about 5440 shopper seconds.

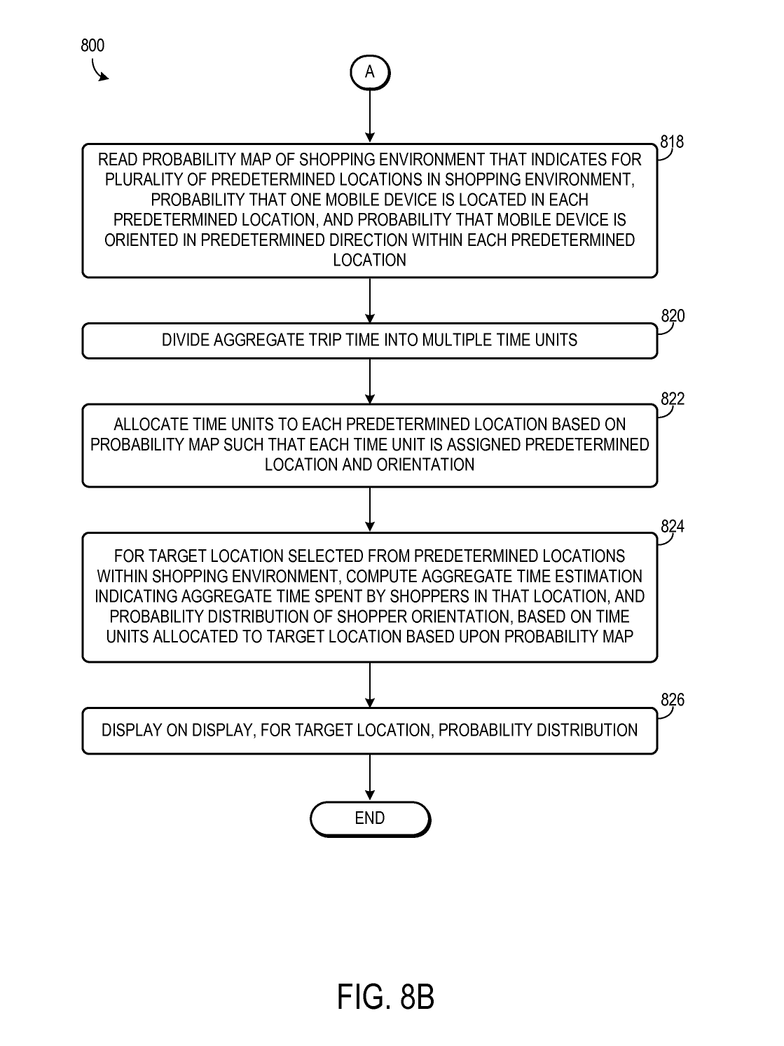

FIGS. 8A and 8b show one embodiment of a method 800 of estimating a distribution of persons in a physical environment. The method 800 may be implemented by the systems and components described above or alternatively may be implemented via other suitable systems and components. As shown in FIG. 8A, at 802, the method 800 may include detecting a first instance of a wireless signal of a mobile device of each of a plurality of persons passing through an entryway into a shopping environment. At 804, the method 800 may include detecting a second instance of the wireless signal from each mobile device passing through the entryway out of the shopping environment. The mobile device may be, for example, a mobile telephone or mobile computing device, or an accessory of the mobile telephone or mobile computing device. The wireless signal may be a BLUETOOTH® signal, and the wireless identifier may be a MAC address of the mobile device.

At 806, the method 800 may include identifying an identifier transmitted in each of the first instances of the wireless signals. At 808, the method 800 may include marking an entrance time for each of the mobile devices to the shopping environment based on the identification of the wireless identifier. At 810, the method 800 may include detecting the wireless identifier transmitted in each of the second instances of the wireless signals. At 812, the method 800 may include marking an exit time for each of the mobile devices based upon the detection of the wireless identifier. At 814, the method 800 may include computing a trip time for each of the mobile devices based on the entrance time and exit time of each mobile device. At 816, the method 800 may include computing an aggregate trip time spent by all mobile devices in the shopping environment during an analysis period.

As shown in FIG. 8B, at 818, the method 800 may include reading a probability map of the shopping environment that indicates for a plurality of predetermined locations in the shopping environment, a probability that one of the mobile devices is located in each predetermined location, and a probability that the mobile device is oriented in a predetermined direction within each predetermined location. As one example, the probability map may be produced by a shopper tracking system that tracks radio frequency identification (RFID) tags, with RFID sensors throughout the shopping environment. The probability map may further indicate a probability that the mobile device is moving at a velocity within the predetermined location. In other examples, the probability map may be produced by an image-based shopper tracking system with cameras throughout the shopping environment, or by transaction log analysis linking shopper trips to locations of products in the shopping environment.

At 820, the method 800 may include dividing the aggregate trip time into multiple time units. At 822, the method 800 may include allocating the time units to each of the predetermined locations based on the probability map, such that each time unit is assigned a predetermined location and orientation. At 824, the method 800 may include, for a target location selected from the predetermined locations within the shopping environment, computing an aggregate time estimation indicating the aggregate time spent by shoppers in that location, and a probability distribution of shopper orientation, based on the time units allocated to the target location based upon the probability map. Finally, at 826, the method 800 may include displaying on a display, for the target location, the probability distribution. Displaying the probability distribution may comprise displaying at least one graph, and/or the probability distribution may displayed with a floor plan of the shopping environment.

The systems and methods described above enable various statistical data to be gathered from shopping environments for a relatively low cost when compared to other tracking systems, such as those utilizing complicated shopper tracking systems as discussed in the Background above. The present systems and methods also leverage wireless transmission devices that are already in use by a percentage of shoppers. The systems and methods described above may be of particular use in generating information about shopping behaviors of aggregate groups of shoppers in different shopping environments. By observing and studying such crowd shopping habits in detail, useful data of the type shown in FIGS. 4 and 5 may be generated, which may inform the product placement and store layout decisions of retailers and brand owners alike. The systems and methods described above further provide an estimated distribution of people in a physical environment, including information on location, orientation, and more. The information may be presented as an allocated probability map to study a shopping environment on a large scale, as in FIG. 6, or an area may be analyzed in detail, as in FIG. 7. Such displayed information may further inform the product placement and store layout decisions.

It will be appreciated that the computing devices described herein may be any suitable computing devices configured to execute the programs described herein. For example, the computing devices may be mainframe computers, personal computers, laptop computers, portable data assistants (PDAs), mobile telephones, networked computing devices, or other suitable computing devices. These devices may be connected to each other via computer networks, such as the Internet. These computing devices typically include a processor and associated volatile and non-volatile memory, and are configured to execute programs stored in non-volatile memory using portions of volatile memory and the processor. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

1. A tracking system estimating a distribution of persons in a physical environment, comprising:
a wireless receiver configured to:
detect a first instance of a wireless signal of a mobile device of each of a plurality of persons passing through an entryway into a shopping environment; and
detect a second instance of the wireless signal from each mobile device passing through the entryway out of the shopping environment; and
a computing device configured to:
identify an identifier transmitted in each of the first instances of the wireless signals;
mark an entrance time for each of the mobile devices to the shopping environment based on the identification of the wireless identifier;
detect the wireless identifier transmitted in each of the second instances of the wireless signals;
mark an exit time for each of the mobile devices based upon the detection of the wireless identifier;
compute a trip time for each of the mobile devices based on the entrance time and exit time of each mobile device;
compute an aggregate trip time spent by all mobile devices in the shopping environment during an analysis period;
read a probability map of the shopping environment that indicates for a plurality of predetermined locations in the shopping environment, a probability that one of the mobile devices is located in each predetermined location, and a probability that the mobile device is oriented in a predetermined direction within each predetermined location;
divide the aggregate trip time into multiple time units;
allocate the time units to each of the predetermined locations based on the probability map, such that each time unit is assigned a predetermined location and orientation;
for a target location selected from the predetermined locations within the shopping environment, compute an aggregate time estimation indicating the aggregate time spent by shoppers in that location, and a probability distribution of shopper orientation, based on the time units allocated to the target location based upon the probability map; and
display on a display associated with the computing device, for the target location, the probability distribution.

2. The tracking system of claim 1, wherein the probability map is produced by a shopper tracking system that tracks radio frequency identification (RFID) tags, with RFID sensors throughout the shopping environment.

3. The tracking system of claim 2, wherein the probability map further indicates a probability that the mobile device is moving at a velocity within the predetermined location.

4. The tracking system of claim 1, wherein the probability map is produced by an image-based shopper tracking system with cameras throughout the shopping environment.

5. The tracking system of claim 1, wherein the probability map is produced by transaction log analysis linking shopper trips to locations of products in the shopping environment.

6. The tracking system of claim 1, wherein the mobile device is a mobile telephone or mobile computing device, or an accessory of the mobile telephone or mobile computing device.

7. The tracking system of claim 5, wherein the accessory is an earpiece, a microphone, headphones, or a wireless dongle.

8. The tracking system of claim 1, wherein the wireless signal is a BLUETOOTH® signal, and the wireless identifier is a MAC address of the mobile device.

9. The tracking system of claim 1, wherein the receiver includes a global positioning system unit.

10. The tracking system of claim 1, wherein displaying the probability distribution comprises displaying at least one graph.

11. The tracking system of claim 1, wherein the probability distribution is displayed with a floor plan of the shopping environment.

12. A method of estimating a distribution of persons in a physical environment, comprising:
detecting a first instance of a wireless signal of a mobile device of each of a plurality of persons passing through an entryway into a shopping environment;
detecting a second instance of the wireless signal from each mobile device passing through the entryway out of the shopping environment;
identifying an identifier transmitted in each of the first instances of the wireless signals;
marking an entrance time for each of the mobile devices to the shopping environment based on the identification of the wireless identifier;
detecting the wireless identifier transmitted in each of the second instances of the wireless signals;
marking an exit time for each of the mobile devices based upon the detection of the wireless identifier;
computing a trip time for each of the mobile devices based on the entrance time and exit time of each mobile device;
computing an aggregate trip time spent by all mobile devices in the shopping environment during an analysis period;
reading a probability map of the shopping environment that indicates for a plurality of predetermined locations in the shopping environment, a probability that one of the mobile devices is located in each predetermined location, and a probability that the mobile device is oriented in a predetermined direction within each predetermined location;
dividing the aggregate trip time into multiple time units;
allocating the time units to each of the predetermined locations based on the probability map, such that each time unit is assigned a predetermined location and orientation;
for a target location selected from the predetermined locations within the shopping environment, computing an aggregate time estimation indicating the aggregate time spent by shoppers in that location, and a probability distribution of shopper orientation, based on the time units allocated to the target location based upon the probability map; and
displaying on a display, for the target location, the probability distribution.

13. The method of claim 12, wherein the probability map is produced by a shopper tracking system that tracks radio frequency identification (RFID) tags, with RFID sensors throughout the shopping environment.

14. The method of claim 13, wherein the probability map further indicates a probability that the mobile device is moving at a velocity within the predetermined location.

15. The method of claim 12, wherein the probability map is produced by an image-based shopper tracking system with cameras throughout the shopping environment.

16. The method of claim 12, wherein the probability map is produced by transaction log analysis linking shopper trips to locations of products in the shopping environment.

17. The method of claim 12, wherein the mobile device is a mobile telephone or mobile computing device, or an accessory of the mobile telephone or mobile computing device.

18. The method of claim 12, wherein the wireless signal is a BLUETOOTH® signal, and the wireless identifier is a MAC address of the mobile device.

19. The method of claim 12, wherein displaying the probability distribution comprises displaying at least one graph.

20. The method of claim 12, wherein the probability distribution is displayed with a floor plan of the shopping environment.
